(19) United States
(12) Patent Application Publication
(10) Pub. No.: US 2010/0074248 A1
(43) Pub. Date: Mar. 25, 2010

(54) VOICE OVER THE INTERNET METHOD AND SYSTEM

(75) Inventors: Foon Yew Kok, Singapore (SG); Wai Keong Chan, Singapore (SG); Pidakala Satyananda Kumar, Singapore (SG)

Correspondence Address: SUGHRUE MION, PLLC, 2100 PENNSYLVANIA AVENUE, N.W., SUITE 800, WASHINGTON, DC, 20037, US

(73) Assignee: ST Electronics (INFO-COMM SYSTEMS) PTE LTD., Singapore (SG)

(21) Appl. No.: 12/517,302

(22) PCT Filed: Dec. 5, 2006
(86) PCT No.: PCT/SG06/00377

§ 371 Date: Jul. 23, 2009

(51) Int. Cl. H04L 12/66; H04M 1/56

(52) U.S. Cl. 370/352; 379/142.18

(57) ABSTRACT

A voice over internet method and system is disclosed to enable radio devices to initiate or terminate a session initiation protocol for transmission of audio data over the internet. A gateway (12) is provided which includes a processor (50) and a software layer (70) to enable signals other than conventional off-hook and on-hook signals to initiate a session. The processor (50) and software (70) detect a control signal which includes data to identify the signal as a request to initiate or terminate a session. The control signal may have a control tone followed by at least one signal tone followed by one further control tone. The control tones represent the data identifying the signal as a request to initiate or terminate a session, and the signal tone identifies the end destination of the call.

### FIELD OF THE INVENTION

This invention relates to a voice data system and method and, in particular, to a voice over internet system and method.

### BACKGROUND OF THE INVENTION

Voice-Over-Internet protocol (VoIP) is a method of enabling voice communications using the Internet as the audio transport medium. All devices wanting to participate in VoIP communications need to be able to be connected to the IP (Internet Protocol) network. Since radios typically do not have an IP network interface, a VoIP radio gateway is used as an interface between the radios and the IP network. The VoIP radio gateway allows radio voice communications over the Internet by performing audio encoding, audio decoding and call signaling. Audio encoding is the process of the converting the analog radio signal to a digital form that can be transmitted in an IP network. Audio decoding is the process of generating the analog signal from digital audio packet received from the IP network. Call signaling refers to the control data being exchanged between the operator console and the VoIP gateway to set up the radio call.

Currently, only the operator console can set up a connection between a radio user to an operator console, another radio or PSTN. The radio user cannot initiate these connections since there is no means to convert dialing digits from radio to SIP (Session Initiation Protocol) messages. This limitation implied that a dispatcher must constantly monitor the radio nets to handle radio users' verbal connection request.

One approach to this problem is to add an external device commonly known as a Radio Interconnect to detect dialing digits from the radio. However, such devices are designed for PSTN operation. Thus another external device is needed to complete the Radio-to-PSTN-to-VoIP conversion. Moreover, radio interconnects support single connections only, hence this approach will be bulky and costly to implement.

### SUMMARY OF THE INVENTION

The object of the present invention is to overcome the above drawbacks.

The invention may be said to reside in a voice data transmission system comprising:
a voice over internet gateway for receiving a signal from a radio device and for converting the signal to a format for transmission over a network to an end destination; and
wherein the voice over internet gateway has a processor for detecting a signal indicative of a requirement to initiate or terminate a session initiation protocol, which signal does not comprise an on-hook signal or an off-hook signal provided by a DTMF telephone, so that the gateway establishes a session initiation protocol transmission over the network or terminates a session initiation protocol transmission over the network.

Because the system utilizes a processor associated with the gateway itself for determining a signal other than an on-hook or off-hook signal which is intended to start or terminate a transmission, the system does not require an additional radio interconnect device, thereby reducing the amount of componentry needed and the complexity and the cost of the system. Furthermore, because the transmission is initiated or terminated by detecting the signal which is other than an on-hook or off-hook signal, a specific signal indicative of the requirement to commence or terminate a transmission can be provided, thereby enabling dial tone information from the radio to be transmitted in the audio stream without that information being mistaken for a request to commence or terminate a transmission.

Preferably the signal indicative of a requirement to initiate or terminate a session initiation protocol comprises a dialing tone signal including data to identify the signal as a request for initiation or termination of the transmission.

Preferably the signal including the data comprises a control tone followed by at least one signal tone, followed by at least one further control tone.

Preferably a signal indicative of a requirement to initiate a transmission and a signal indicative of a requirement to terminate a transmission include the same control tones but different tone signals.

Preferably the tone signal to initiate a session comprises the number to be called and the processor is for extracting that number from between the control tones.

Preferably a plurality of transmissions can originate from a common radio port of the gateway with the transmission being half duplex. That is, there can be many listeners but only one talker at a time.

Preferably the gateway controls which radio device is allowed to transmit.

The invention may also be said to reside in a voice data transmission system, comprising:
a voice over internet gateway for receiving a signal from a radio device and for converting the signal to a format for transmission over a network to an end destination; and
wherein the voice over internet gateway has a processor for receiving an off-hook signal from a DTMF telephone or an on-hook signal from a DTMF telephone to initiate or terminate a session initiation protocol so that the gateway establishes a session initiation protocol transmission over the network, or terminates a session initiation protocol transmission over the network, the processor being for also receiving a signal from a radio device which is not able to produce an off-hook or on-hook signal, the signal comprising a tone signal containing control data for identifying the signal as a signal to initiate or terminate a session initiation protocol so that upon receipt of the signal, the gateway establishes a session initiation protocol transmission over the network or terminates a session initiation protocol transmission over the network.

Thus, the gateway is able to process conventional requests for establishing transmission or terminating transmission based on the off-hook or on-hook signal, and also transmission from a radio device not having the ability to produce an off-hook or on-hook signal to establish a transmission over the internet or terminate a transmission over the internet.

Preferably the signal indicative of a requirement to initiate or terminate a session initiation protocol comprises a dialing tone signal including data to identify the signal as a request for initiation or termination of the transmission.

Preferably the signal including the data comprises a control tone followed by at least one signal tone, followed by at least one further control tone.

Preferably a signal indicative of a requirement to initiate a transmission and a signal indicative of a requirement to terminate a transmission include the same control tones but different tone signals.

Preferably the tone signal to initiate a session comprises the number to be called and the processor is for extracting that number from between the control tones.

Preferably a plurality of transmissions can originate from a common radio port of the gateway with the transmission being half duplex.

Preferably the gateway controls which radio device is allowed to transmit.

The invention may be said to reside in a voice data transmission method comprising:
receiving a signal from a radio device and for converting the signal to a format for transmission over a network to an end destination; and
detecting a signal indicative of a requirement to initiate or terminate a session initiation protocol, which signal does not comprise an on-hook signal or an off-hook signal provided by a DTMF telephone, to establish a session initiation protocol transmission over the network or terminates a session initiation protocol transmission over the network.

Preferably the signal indicative of a requirement to initiate or terminate a session initiation protocol comprises a dialing tone signal including data to identify the signal as a request for initiation or termination of the transmission.

Preferably the signal including the data comprises a control tone followed by at least one signal tone, followed by at least one further control tone.

Preferably a signal indicative of a requirement to initiate a transmission and a signal indicative of a requirement to terminate a transmission include the same control tones but different tone signals.

Preferably the tone signal to initiate a session comprises the number to be called and the processor is for extracting that number from between the control tones.

Preferably a plurality of transmissions originate from a common radio port of the gateway with the transmission being half duplex.

Preferably the method further comprises controlling which radio device is allowed to transmit.

The invention may also be said to reside in a voice data transmission method, comprising:
receiving a signal from a radio device and for converting the signal to a format for transmission over a network to an end destination;
receiving an off-hook signal from a DTMF telephone or an on-hook signal from a DTMF telephone to initiate or terminate a session initiation protocol so that the gateway establishes a session initiation protocol transmission over the network, or terminates a session initiation protocol transmission over the network; and
receiving a signal from a radio device which is not able to produce an off-hook or on-hook signal, the signal comprising a tone signal containing control data for identifying the signal as a signal to initiate or terminate a session initiation protocol to establish a session initiation protocol transmission over the network or terminates a session initiation protocol transmission over the network.

Preferably the signal indicative of a requirement to initiate or terminate a session initiation protocol comprises a dialing tone signal including data to identify the signal as a request for initiation or termination of the transmission.

Preferably the signal including the data comprises a control tone followed by at least one signal tone, followed by at least one further control tone.

Preferably a signal indicative of a requirement to initiate a transmission and a signal indicative of a requirement to terminate a transmission include the same control tones but different tone signals.

Preferably the tone signal to initiate a session comprises the number to be called and the processor is for extracting that number from between the control tones.

Preferably a plurality of transmissions originate from a common radio port of a gateway with the transmission being half duplex.

Preferably the method further comprises controlling which radio device is allowed to transmit.

### BRIEF DESCRIPTION OF THE DRAWINGS

A preferred embodiment of the invention will be described, by way of example, with reference to the accompanying drawings in which:

FIG. 1 is a diagram illustrating the concept of radio voice communication over the internet by a voice over internet protocol radio gateway;

FIG. 2 is a diagram illustrating communications using a radio inter-connector device;

FIG. 3 is a diagram according to one embodiment of the invention to provide a communication path for eight radio devices to initiate multiple calls;

FIG. 4 is a diagram showing software architecture of the preferred embodiment of the invention;

FIG. 5 is a diagram showing the configuration of the voice over internet protocol radio gateway;

FIG. 6 is a diagram showing point-to-point call equipment connection;

FIG. 7 is a flowchart showing the manner in which a call is set up;

FIG. 8 is a diagram showing multi-party call equipment connections;

FIG. 9 is a diagram explaining the transmission control mechanism;

FIG. 10 is a diagram showing call termination equipment connection;

FIG. 11 is a flowchart showing how call termination takes place; and

FIG. 12 is a diagram showing one application of the invention.

### DETAILED DESCRIPTION OF THE PREFERRED EMBODIMENT

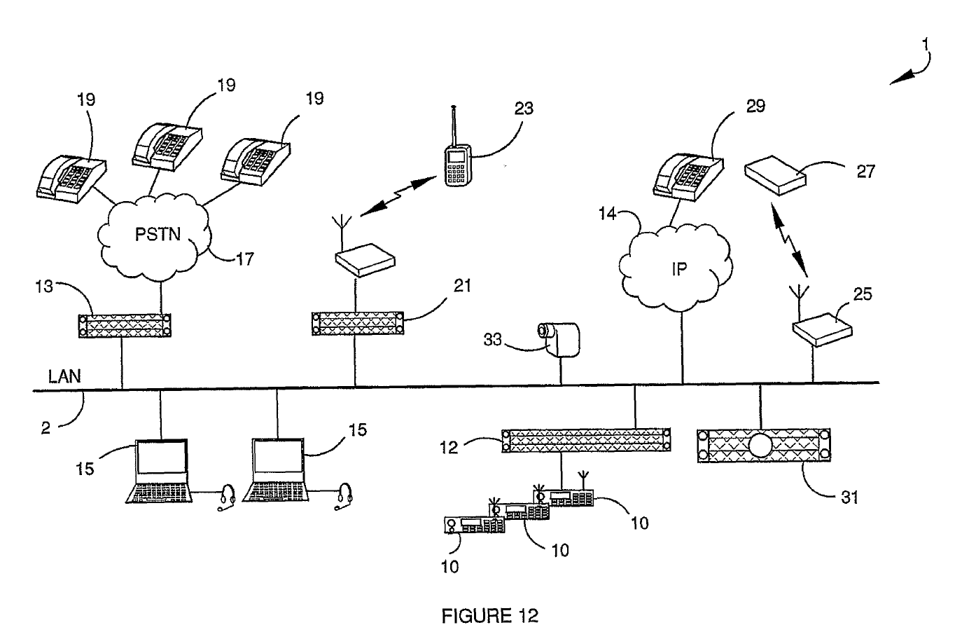

One application of the present invention is shown in FIG. 12. FIG. 12 relates to a quick deployable emergency integrated communication system which can be used by emergency services in the event of an emergency situation. When responding to a crisis, various different agencies need to communicate with one another. Typically, such agencies have their own communication networks, which means that when various agencies do arrive at an incident scene, their communication system does not necessarily allow them to communicate to another emergency agency or back to an incident commander.

To address this problem, an emergency integrated communication system 1 shown in FIG. 12 can be used. The system is typically mounted in a vehicle. By using voice over internet technology, the system 1 places disparate communication systems on a common network platform.

As is shown in FIG. 12, the emergency integrated communication system comprises a local area network 2 to which is connected operator consoles 15, an FXO gateway 13, for supplying communications over the PSTN network 17 to DTMF telephones 19. The local area network 2 also has connected to it FXS gateway 21 for providing communication via GSM telephones 23, and a wireless AP network 25 for providing communication to a PDA 27. Radio gateway 12 and base stations 10 are also connected to the local area network for supplying voice over the internet signals via VOIP network 14 to, for example, an IP phone 29. The local area network 2 may also have connected to it a VOIP logger 31 and a web camera 33 for providing images.

Other environments in which the invention can be used include public security agencies, oil exploration, transportation, etc.

In an emergency integrated communication system of the type described with reference to FIG. 12, there are three main areas of use, mainly interoperability, interconnectivity and voice data convergence. Interoperability enables the gateway 12 to produce voice over internet protocol packets that are used as the common media for switch audio. Interconnectivity enables connection of the VOIP gateway to other communication networks such as the PSTN which effectively extends the range of the radio gateway. This, for example, allows a headquarters of an emergency service to be connected to forward command posts in the field. Voice data convergence enables the VOIP packets to be transported using the same infrastructure as the data network. This therefore saves on installation, as well as providing an additional communication link to the forward command posts.

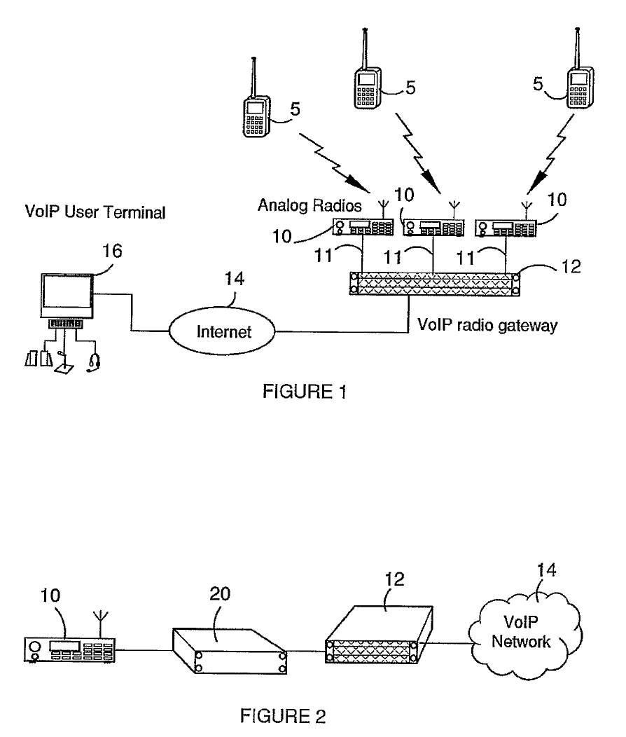

FIG. 1 is a diagram showing the concept of radio communications over the internet. With reference to FIG. 1, a plurality of radio devices 5 such as analog radios provide analog audio signals to a base radio 10 connected to gateway 12 by radio interface cable 11. The radio gateway performs audio encoding, audio decoding and call signalling to enable transmission of signals over the internet 14 to an end destination such as voice over internet protocol user terminal 16. Audio encoding is the process of converting analog radio signals to a digital form that can be transmitted in an IP network. Audio decoding is the process of generating the analog signal from digital audio packets received from the IP network. Call signalling refers to the control data being exchanged between an operator console and the gateway 12 to set up the transmission (that is, the radio call). Radio users cannot initiate connections themselves, since there is no means to convert dialing digits from radio to SIP messages. Thus, a dispatcher must constantly monitor the radio networks to handle radio user's verbal connection requests.

FIG. 2 shows that this problem can be solved by adding a radio interconnect device 20 to the system to detect dialing digits from the radio device 10. However, such devices are designed for PSTN operation from a telephone on the PST network and therefore, a still further device is needed to complete the radio to PSTN to gateway 12 connection.

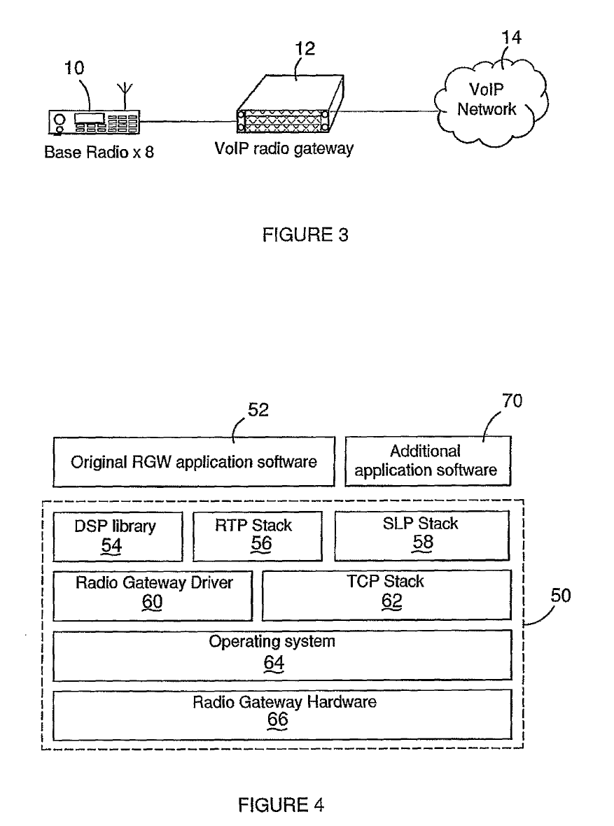

FIG. 3 is a diagram showing a preferred embodiment of the invention in which only the gateway 12 is needed to initiate or terminate a call from radio base 10 to the internet 14. The gateway 12 includes a DTMF detection features for detecting dialing tones. Typically, if connection is being made from a DTMF telephone, an off-hook signal is used to set up the call and an on-hook signal is used to terminate the call. However, radio device 5 and radio base 10 do not produce off-hook or on-hook signals and therefore, such signals cannot be used to initiate or terminate a call from the radio base 10. The gateway 12 is therefore able to initiate or terminate calls from a DTMF telephone via the PSTN in the conventional way by detecting the off-hook and on-hook signals. However, according to the preferred embodiment of the invention, the gateway 12 uses the DTMF detection function in order to detect signals from the radio device 10 to initiate and terminate transmissions over the internet 14.

Communications can also be provided directly from the radio base 10. Such communications can include broadcast messages such as weather conditions, navigation hazard warnings or safety messages.

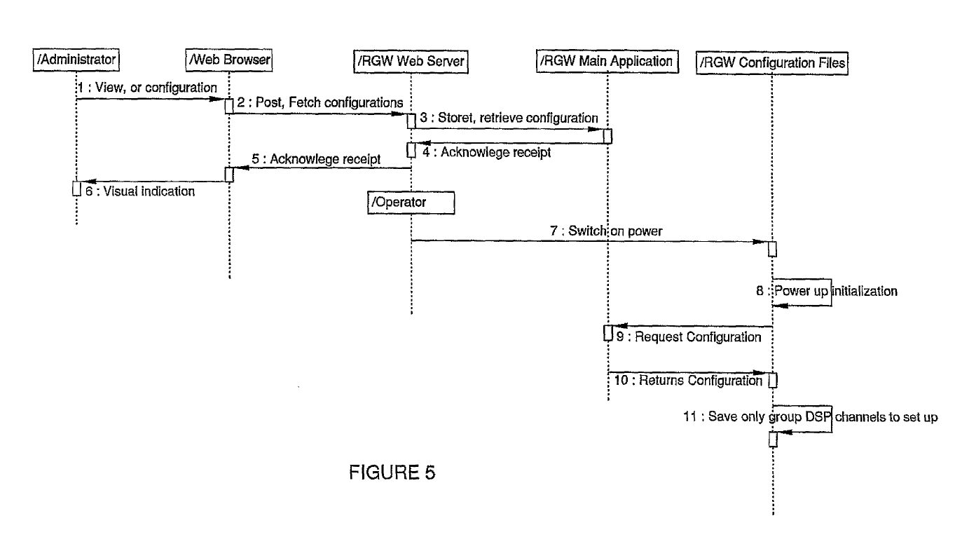

FIG. 4 is a software architecture diagram of the preferred embodiment of the gateway 12. The gateway 12 has a processor 50 which is controlled by conventional radio gateway application software 52. The processor 50 may comprise or include or control a DSP (Digital Signal Processing) library which maintains a library of DSP channels, RTP (Real Time Transport Protocol) stack for real time transmission of data, SIP stack 58, radio gateway driver 60, TCP (Transport Control Protocol) stack 62 which moves multiple data packets between applications, operating system 64 and gateway hardware 66.

According to the preferred embodiment of the invention, an additional software layer 70 is provided which controls the DTMF detection by the processor 50 so the processor 50 can recognize whether such a signal is indicative of the request to initiate a transmission according to the session initiation protocol and terminate a transmission according to the session initiation protocol, so that those signals can be distinguished from DTMF tone signals which merely are intended to comprise part of the audio data which is to be transmitted from a radio device 5 and radio base 10 to an end user.

DTMF detection by the processor 50 under the control of the software 70 can only take place after a DSP channel is allocated. That is, a call must be established first. To enable this to happen, upon power up a dummy connection is made. To avoid having to establish a dummy connection for every radio port that a radio user could dial from, the SIP initiation capability is enabled only for ports that the radio user is expected to dial from. A web browser is used to enable or disable the DTMF detection for each radio port.

FIG. 5 illustrates the sequence of enabling or disabling the DTMF detection for radio ports. As shown in FIG. 5, to do this, an administrator types in the URL of the radio gateway 12 in a browser such as Internet Explorer, and types in his user ID, password and subsequently sets the configuration using the onscreen user interface provided as per step 1. The configuration is submitted to a web server built into the gateway 12 as per step 2. These configurations are stored as files within the radio gateway 12 as per step 3.

An acknowledgment is sent back to the administrator to indicate that the configuration has been accepted, as shown by steps 4, 5 and 6 in FIG. 5. At step 7 the operator turns on the radio gateway 12 and the gateway will automatically run up a power initialisation procedure as shown at step 8. The initialisation process at step 8 reads the configuration files retrieved at step 3 so that the gateway main application requests configurations from the configuration files at step 9. At step 10 the configuration files are read and at step 11 the gateway main application seizes only the required number of DSP channels to match the configuration files which are required.

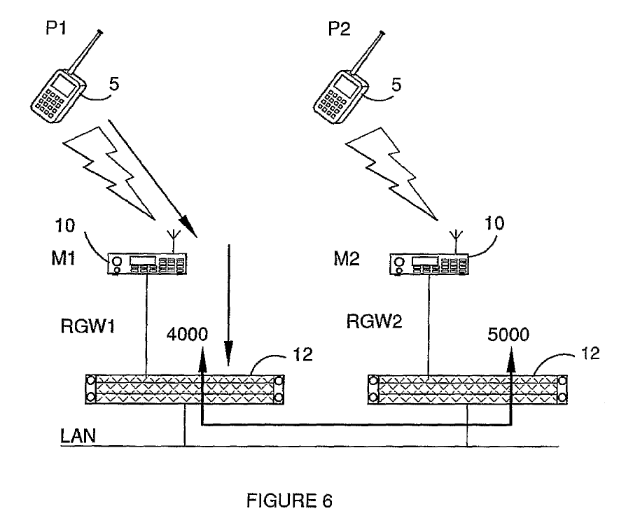

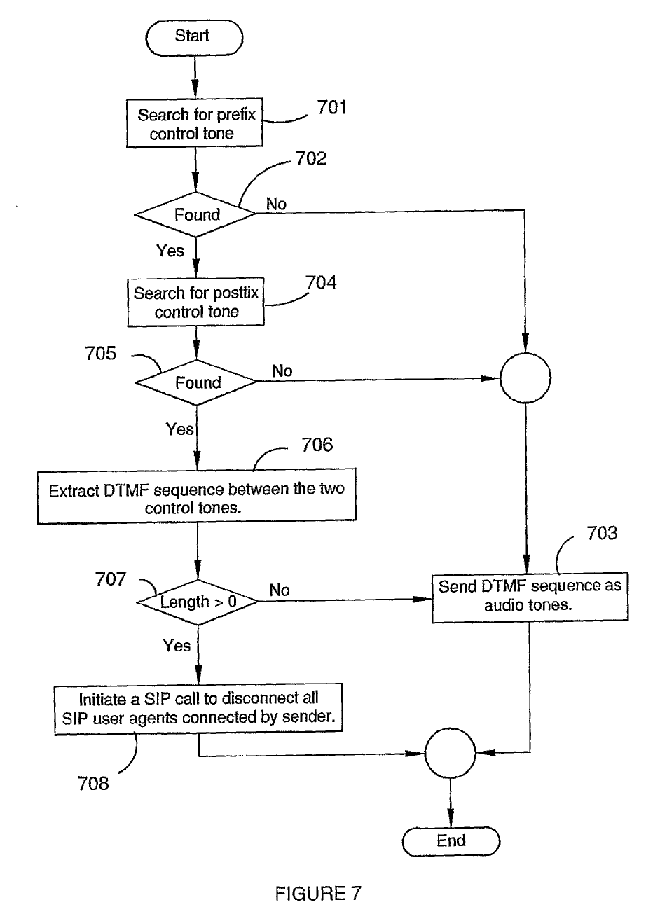

Radio frequency signals are received from radio devices 5 at the received channel of base radio 10. The received channel of the base radio 10 is connected to the audio input line of the gateway 12 by the radio interface cable 11, and the radio gateway 12 constantly monitors this line for DTMF digits. A call is initiated according to the SIP as shown in FIG. 7 by a user of portable radio device 5 holding down PTT (Push To Talk) button (not shown) on the user's portable radio 5, as shown in FIG. 6. Whilst the button is held down, the user presses the sequence *5000# and releases the PTT button. *5000# will be transmitted from the radio device 5 to the radio base 10. The number 5000 in the signal *5000# is the ID of the destination port in radio gateway 12 labelled RGW2 in FIG. 6. Base radio 10 labelled M1 in FIG. 6, which is the receiving base radio station, is connected to port 4000 of the receiving gateway 12 labelled RGW1 in FIG. 6. The processor 50 under the control of software 70 in gateway 12 detects the sequence *5000# and the * and the # are control tones or markers used to indicate a call request.

Gateway 12 labelled RGW1 in FIG. 6 extracts the digits 5000 contained within the control tones or markers * and # and sends out the appropriate SIP signal message to set up an SIP call to port 5000 in radio gateway 12 labelled RGW2 in FIG. 6.

If the user omits the control tones * and # and simply dials 5000, RGW1 detects 5000 and the absence of the control tones or markers means that no SIP signalling is initiated.

If the user holds down the PTT button and transmits the sequence *6000 then realises he has entered the wrong digits and releases the PTT button without completing the sequence with a #, RGW1 will detect *6000 and the lack of the closing control tone or marker # means that no SIP signal is initiated.

As is shown with reference to the flowchart in FIG. 7, the processor 50 under the control of the software 70 therefore searches for the prefix control tone *. If control tones are received but the control tone is not present, the process moves from step 701 and step 702 to step 703 in which the data is simply treated as audio data. If, at step 702, the answer is yes and the prefix control tone * is received, the process then searches for the postfix control tone # at step 704. At step 705 a decision is made as to whether the postfix control tone is found. If no, the process goes to step 703 and the data is simply sent as audio tones as part of the audio data file. If the # postfix is found, the processor extracts the DTMF sequence between the two control tones at step 706 and then determines whether the length between those control tones is greater than zero at step 707. If no, the control tones are treated simply as data and are sent as audio data at step 703. If yes (i.e. there is tones between the * and the #), an SIP call to the SIP user agent using the digits between the * and the # is set up at step 708.

The gateways 12 shown in FIG. 6 may establish calls between a radio device 5 to another radio device or to a telephone via the PSTN network in the manner described above by using the * and # tones to identify a request to initiate a call. The gateways 12 may transmit voice calls from telephones via the PSTN network in the conventional way, or from a telephone to a radio device at the destination.

Multiple connections can be made as long as there are DSP channels available in the processor 50 because the gateway 12 will continue to allow new SIP calls to be initiated from the radio user 5. In the case of a call between connected telephones, the pair of connected phones is in full duplex, i.e. phone users may talk and listen simultaneously. A pair of connected radio devices 5 is in half duplex, i.e. a radio user is normally in listening mode and needs to hold down the PTT button when he wants to talk, and is unable to listen until he releases the PTT button.

When a number of telephones are connected to a base radio 10, each phone needs to behave like a radio device 5. The gateway 12 assumes the role of the PTT controller. To request for PTT, a connected phone must send the DTMF digit * to the gateway 12. To release the PTT, it needs to send the DTFM digit #. Only one talker is allowed at any time. All connected devices 5 and radio bases 10 would be able to hear the audio.

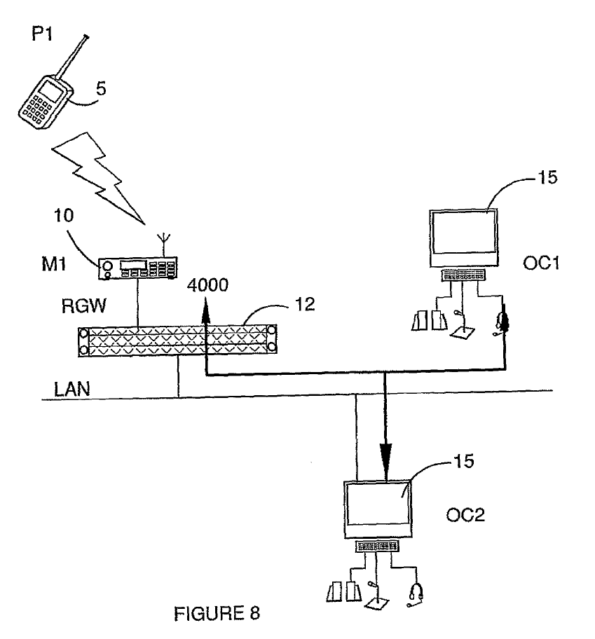

FIG. 8 shows the multi-party call equipment connection diagram in which gateway 12 and base radio 10 are connected to operator consoles 15. The consoles 15 may be regarded in a simplistic sense as phones.

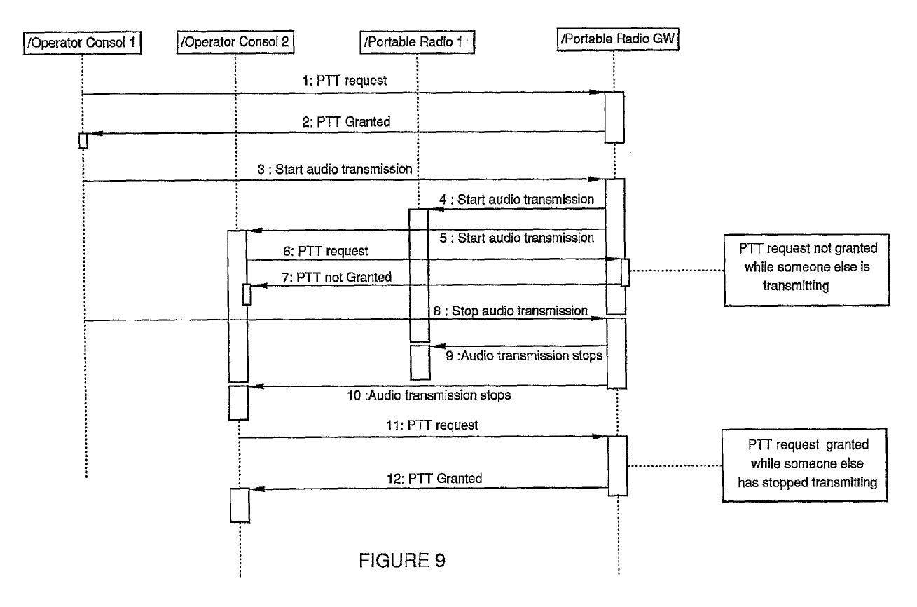

FIG. 9 is a diagram showing the transmission control mechanism. The two operator controls 15 shown in FIG. 8 are labelled OC1 and OC2 and will be described as such in the following description.

OC1 sends a * to request for PTT as per step 1 in FIG. 9. The radio gateway 12 grants the request as per step 2 in FIG. 9. OC1 switches to transmit mode and starts to talk as per step 3 and the radio gateway 12 retransmits the voice packets to all other connected devices (i.e. the OC2 in FIG. 8) as per step 4 and step 5. At step 6, while OC1 is still talking, OC2 requests for PTT. The radio gateway 12 sends a request denial to OC2 at step 7 because OC1 is still talking. At step 80C1 stops talking and sends a # to request for PTT off. He then listens for transmissions from others. At step 9 audio transmission stops. OC2 requests for PTT again and this time, radio gateway 12 grants the request so that OC2 can now commence talking to radio device 5 and OC1.

In order for a call to be terminated, a dialing digit sequence is sent while the radio user of radio device 5 holds down the PTT button on his radio and enters the sequence *000# and then releases the PTT button. The gateway 12 receives that information and because of the inclusion of the * and #, recognises that the data is not simply audio data to be transmitted but a control signal and the processor 50 extracts the sequence 000 between the * and the #. That signal represents a request to terminate the call and terminates the call from the radio device 5.

The gateway 12 maintains a separate record for each connection initiated by it and upon receiving the signal from the connected devices requesting termination, will initiate SIP signalling to terminate each connection one after another.

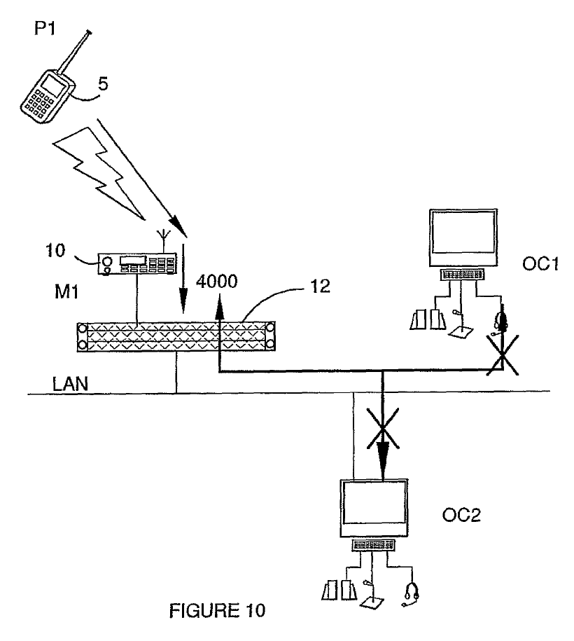

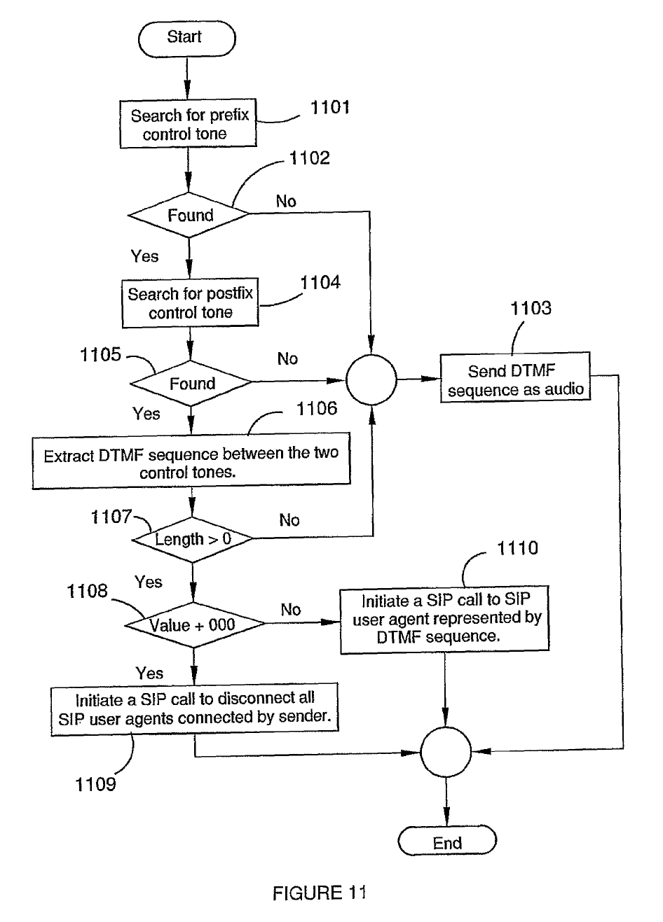

FIG. 10 represents the call termination in which like reference numerals indicate like parts to those described with reference to FIG. 9, and FIG. 11 is a flowchart showing how a call termination is made.

With reference to FIG. 11, at step 1101 the processor 50 under the control of the software 70 searches for the prefix control tone *. If the prefix * is not found at step 1102 the process moves to step 1103 and the DTMF sequence is treated as audio data and forwarded as such.

If the * is found the process moves to step 1104 where a search is made for the postfix control tone #. If found at step 1105 the process moves to step 1106. If not, the process goes to step 1103 and the DTMF sequence sent as an audio signal as previously described.

At step 1106, the DTMF sequence between the control tones * and # is extracted by the processor 50 under the control of the software 70, and at step 1107 a determination is made as to whether the length of the extracted sequence is greater than zero. If not, meaning that no data was contained between the control tones, the control tones are treated simply as audio data and sent at step 1103 as such. If there is data between the * and the # equivalent to the value 000, as determined at step 1108, the SIP is initiated to disconnect all SIP user agents connected by the sender at step 1109. If the answer at step 1108 was no, the process moves to step 1110 and an SIP call is initiated as represented by the DTMF sequence which is extracted as per the flowchart of FIG. 7.

In order for the gateway 12 software to provide SIP initiating services, it needs to be able to derive the SIP URL from the dialing digits received. When registered to an SIP server, this is not a problem as received digits are simply passed on unmodified to the SIP server to be resolved. When the gateway 12 is working without an SIP server, it maintains a routing table to carry out the resolution. The routing table is accessible via the built in web server and browser in the gateway 12. Since such routing methods are well known, they will not be described in further detail herein.

Since modifications within the spirit and scope of the invention may readily be effected by persons skilled within the art, it is to be understood that this invention is not limited to the particular embodiment described by way of example hereinabove.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

1. A voice data transmission system comprising:
a voice over internet gateway for receiving a signal from a radio device and for converting the signal to a format for transmission over a network to an end destination; and
wherein the voice over internet gateway has a processor for detecting a signal indicative of a requirement to initiate or terminate a session initiation protocol, which signal does not comprise an on-hook signal or an off-hook signal provided by a DTMF telephone, so that the gateway establishes a session initiation protocol transmission over the network or terminates a session initiation protocol transmission over the network.

2. The system of claim 1 wherein the signal indicative of a requirement to initiate or terminate a session initiation protocol comprises a dialing tone signal including data to identify the signal as a request for initiation or termination of the transmission.

3. The system of claim 2 wherein the signal including the data comprises a control tone followed by at least one signal tone, followed by at least one further control tone.

4. The system of claim 2 wherein a signal indicative of a requirement to initiate a transmission and a signal indicative of a requirement to terminate a transmission include the same control tones but different tone signals.

5. The system of claim 2 wherein the tone signal to initiate a session comprises the number to be called and the processor is for extracting that number from between the control tones.

6. The system of claim 1 wherein a plurality of transmissions can originate from a common radio port of the gateway with the transmission being half duplex.

7. The system of claim 6 wherein the gateway controls which radio device is allowed to transmit.

8. The system of claim 1 wherein the system is a voice over internet system and the network comprises the internet.

9. A voice data transmission system, comprising:
a voice over internet gateway for receiving a signal from a radio device and for converting the signal to a format for transmission over a network to an end destination;
wherein the voice over internet gateway has a processor for receiving an off-hook signal from a DTMF telephone or an on-hook signal from a DTMF telephone to initiate or terminate a session initiation protocol so that the gateway establishes a session initiation protocol transmission over the network, or terminates a session initiation protocol transmission over the network; and
wherein the processor being for also receiving a signal from a radio device which is not able to produce an off-hook or on-hook signal, the signal comprising a tone signal containing control data for identifying the signal as a signal to initiate or terminate a session initiation protocol so that upon receipt of the signal, the gateway establishes a session initiation protocol transmission over the network or terminates a session initiation protocol transmission over the network.

10. The system of claim 9 wherein the signal indicative of a requirement to initiate or terminate a session initiation protocol comprises a dialing tone signal including data to identify the signal as a request for initiation or termination of the transmission.

11. The system of claim 10 wherein the signal including the data comprises a control tone followed by at least one signal tone, followed by at least one further control tone.

12. The system of claim 11 wherein a signal indicative of a requirement to initiate a transmission and a signal indicative of a requirement to terminate a transmission include the same control tones but different tone signals.

13. The system of claim 10 wherein the tone signal to initiate a session comprises the number to be called and the processor is for extracting that number from between the control tones.

14. The system of claim 9 wherein a plurality of transmissions can originate from a common radio port of the gateway with the transmission being half duplex.

15. The system of claim 9 wherein the gateway controls which radio device is allowed to transmit.

16. The system of claim 9 wherein the system is a voice over internet system and the network comprises the internet.

17. A voice data transmission method comprising:
receiving a signal from a radio device and for converting the signal to a format for transmission over a network to an end destination; and
detecting a signal indicative of a requirement to initiate or terminate a session initiation protocol, which signal does not comprise an on-hook signal or an off-hook signal provided by a DTMF telephone, to establish a session initiation protocol transmission over the network or terminates a session initiation protocol transmission over the network.

18. The method of claim 17 wherein the signal indicative of a requirement to initiate or terminate a session initiation protocol comprises a dialing tone signal including data to identify the signal as a request for initiation or termination of the transmission.

19. The method of claim 18 wherein the signal including the data comprises a control tone followed by at least one signal tone, followed by at least one further control tone.

20. The method of claim 18 wherein a signal indicative of a requirement to initiate a transmission and a signal indicative of a requirement to terminate a transmission include the same control tones but different tone signals.

21. The method of claim 18 wherein the tone signal to initiate a session comprises the number to be called and the processor is for extracting that number from between the control tones.

22. The method of claim 17 wherein a plurality of transmissions originate from a common radio port of the gateway with the transmission being half duplex.

23. The method of claim 22 wherein the method further comprises controlling which radio device is allowed to transmit.

24. The method of claim 17 wherein the voice data is transmitted over the internet and the system comprises the internet.

25. A voice data transmission method, comprising:
receiving a signal from a radio device and for converting the signal to a format for transmission over a network to an end destination;
receiving an off-hook signal from a DTMF telephone or an on-hook signal from a DTMF telephone to initiate or terminate a session initiation protocol so that the gateway establishes a session initiation protocol transmission over the network, or terminates a session initiation protocol transmission over the network; and
receiving a signal from a radio device which is not able to produce an off-hook or on-hook signal, the signal comprising a tone signal containing control data for identifying the signal as a signal to initiate or terminate a session initiation protocol to establish a session initiation protocol transmission over the network or terminates a session initiation protocol transmission over the network.

26. The method of claim 25 wherein the signal indicative of a requirement to initiate or terminate a session initiation protocol comprises a dialing tone signal including data to identify the signal as a request for initiation or termination of the transmission.

27. The method of claim 26 wherein the signal including the data comprises a control tone followed by at least one signal tone, followed by at least one further control tone.

28. The method of claim 26 wherein a signal indicative of a requirement to initiate a transmission and a signal indicative of a requirement to terminate a transmission include the same control tones but different tone signals.

29. The method of claim 25 wherein the tone signal to initiate a session comprises the number to be called and the processor is for extracting that number from between the control tones.

30. The method of claim 25 wherein a plurality of transmissions originate from a common radio port of a gateway with the transmission being half duplex.

31. The method of claim 25 wherein the method further comprises controlling which radio device is allowed to transmit.

32. The method of claim 25 wherein the voice data is transmitted over the internet and the system comprises the internet.
